(19) United States
(12) Patent Application Publication
(10) Pub. No.: US 2025/0142464 A1
(43) Pub. Date: May 1, 2025

(54) WIRELESS COMMUNICATION SESSIONS FOR RELAY ENTITIES OPERATING IN A VISITED PUBLIC LAND MOBILE NETWORK

(71) Applicant: QUALCOMM Incorporated, San Diego, CA (US)

(72) Inventors: Lenaig Genevieve CHAPONNIERE, La Jolla, CA (US); Sebastian SPEICHER, Wallisellen (CH); Karl Georg HAMPEL, Jersey City, NJ (US); Hong CHENG, Basking Ridge, NJ (US); Francesco PICA, San Diego, CA (US); Haris ZISIMOPOULOS, London (GB)

(21) Appl. No.: 18/730,271

(22) PCT Filed: Feb. 14, 2023
(86) PCT No.: PCT/US2023/062539

§ 371 Date: Jul. 18, 2024

(30) Foreign Application Priority Data
Mar. 28, 2022 (GR) 20220100266

(51) Int. Cl. H04W 48/18; H04W 76/10

(52) U.S. Cl. CPC H04W 48/18; H04W 76/10

(57) ABSTRACT

Various aspects of the present disclosure generally relate to wireless communication. In some aspects, a relay entity may establish a wireless communication session with a network entity associated with a visited public land mobile network (VPLMN), wherein the relay entity is configured to perform access node functions and user equipment (UE) functions, and wherein establishing the wireless communication session includes enabling wireless communication for both the access node functions and the UE functions via the VPLMN. The relay entity may perform a relay service via the access node functions. Numerous other aspects are described.

### CROSS-REFERENCE TO RELATED APPLICATION

This Patent Application claims priority to Greece patent application Ser. No. 20/220,100266, filed on Mar. 28, 2022, entitled “WIRELESS COMMUNICATION SESSIONS FOR RELAY ENTITIES OPERATING IN A VISITED PUBLIC LAND MOBILE NETWORK,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for wireless communication sessions for relay entities operating in a visited public land mobile network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a relay entity. The method may include establishing a wireless communication session with a network entity associated with a visited public land mobile network (VPLMN), wherein the relay entity is configured to perform access node functions and user equipment (UE) functions, and wherein establishing the wireless communication session includes enabling wireless communication for both the access node functions and the UE functions via the VPLMN. The method may include performing a relay service via the access node functions.

Some aspects described herein relate to a method of wireless communication performed by a network entity associated with a VPLMN. The method may include establishing a wireless communication session with a relay entity, wherein the relay entity is configured to perform access node functions and UE functions, and wherein establishing the wireless communication session includes enabling wireless communication for both the access node functions and the UE functions via the VPLMN. The method may include receiving, from the relay entity, a communication associated with the access node functions of the relay entity.

Some aspects described herein relate to an apparatus for wireless communication at a relay entity. The apparatus may include a memory and one or more processors coupled to the memory. The one or more processors may be configured to establish a wireless communication session with a network entity associated with a VPLMN, wherein the relay entity is configured to perform access node functions and UE functions, and wherein establishing the wireless communication session includes enabling wireless communication for both the access node functions and the UE functions via the VPLMN. The one or more processors may be configured to perform a relay service via the access node functions.

Some aspects described herein relate to an apparatus for wireless communication at a network entity associated with a VPLMN. The apparatus may include a memory and one or more processors coupled to the memory. The one or more processors may be configured to establish a wireless communication session with a relay entity, wherein the relay entity is configured to perform access node functions and UE functions, and wherein establishing the wireless communication session includes enabling wireless communication for both the access node functions and the UE functions via the VPLMN. The one or more processors may be configured to receive, from the relay entity, a communication associated with the access node functions of the relay entity.

Some aspects described herein relate to a non-transitory computer-readable medium that stores a set of instructions for wireless communication by a relay entity. The set of instructions, when executed by one or more processors of the relay entity, may cause the relay entity to establish a wireless communication session with a network entity associated with a VPLMN, wherein the relay entity is configured to perform access node functions and UE functions, and wherein establishing the wireless communication session includes enabling wireless communication for both the access node functions and the UE functions via the VPLMN. The set of instructions, when executed by one or more processors of the relay entity, may cause the relay entity to perform a relay service via the access node functions.

Some aspects described herein relate to a non-transitory computer-readable medium that stores a set of instructions for wireless communication by a network entity associated with a VPLMN. The set of instructions, when executed by one or more processors of the network entity, may cause the network entity to establish a wireless communication session with a relay entity, wherein the relay entity is configured to perform access node functions and UE functions, and wherein establishing the wireless communication session includes enabling wireless communication for both the access node functions and the UE functions via the VPLMN. The set of instructions, when executed by one or more processors of the network entity, may cause the network entity to receive, from the relay entity, a communication associated with the access node functions of the relay entity.

Some aspects described herein relate to an apparatus for wireless communication. The apparatus may include means for establishing a wireless communication session with a network entity associated with a VPLMN, wherein the apparatus is configured to perform access node functions and UE functions, and wherein establishing the wireless communication session includes enabling wireless communication for both the access node functions and the UE functions via the VPLMN. The apparatus may include means for performing a relay service via the access node functions.

Some aspects described herein relate to an apparatus for wireless communication associated with a VPLMN. The apparatus may include means for establishing a wireless communication session with a relay entity, wherein the relay entity is configured to perform access node functions and UE functions, and wherein establishing the wireless communication session includes enabling wireless communication for both the access node functions and the UE functions via the VPLMN. The apparatus may include means for receiving, from the relay entity, a communication associated with the access node functions of the relay entity.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of radio access networks, in accordance with the present disclosure.

FIG. 4 is a diagram illustrating an example of an integrated access and backhaul network architecture, in accordance with the present disclosure.

FIG. 5 is a diagram illustrating an example of an open radio access network (O-RAN) architecture, in accordance with the present disclosure.

FIG. 6 is a diagram illustrating an example of sidelink communications, in accordance with the present disclosure.

FIG. 7 is a diagram illustrating an example of sidelink communications and access link communications, in accordance with the present disclosure.

FIG. 8 is a diagram of an example associated with establishing a wireless communication session for relay entities operating in a visited public land mobile network, in accordance with the present disclosure.

FIG. 9 is a diagram illustrating an example process performed, for example, by a relay entity, in accordance with the present disclosure.

FIG. 10 is a diagram illustrating an example process performed, for example, by a network entity, in accordance with the present disclosure.

FIG. 11 is a diagram of an example apparatus for wireless communication.

FIG. 12 is a diagram of an example apparatus for wireless communication.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

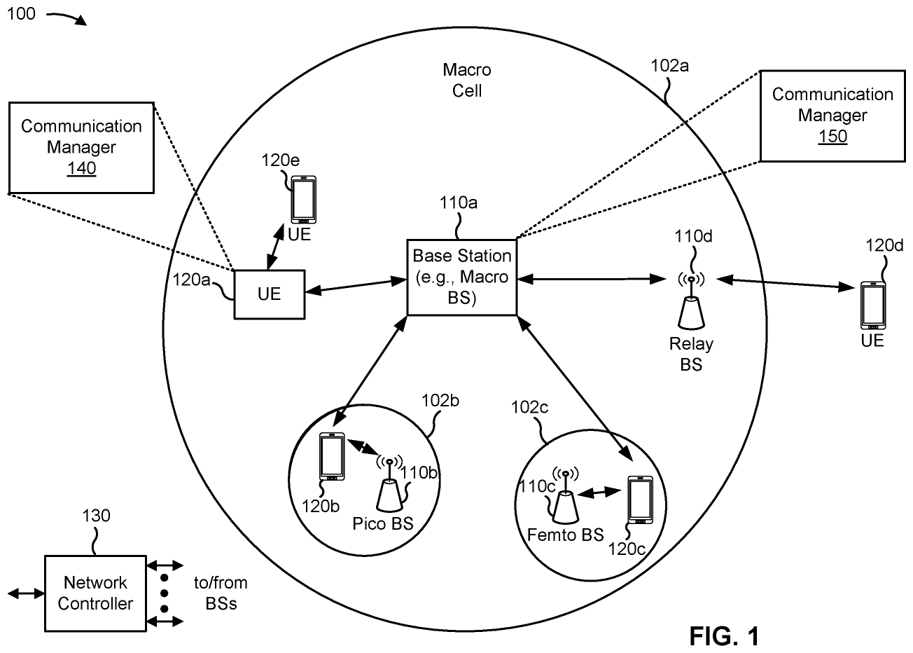

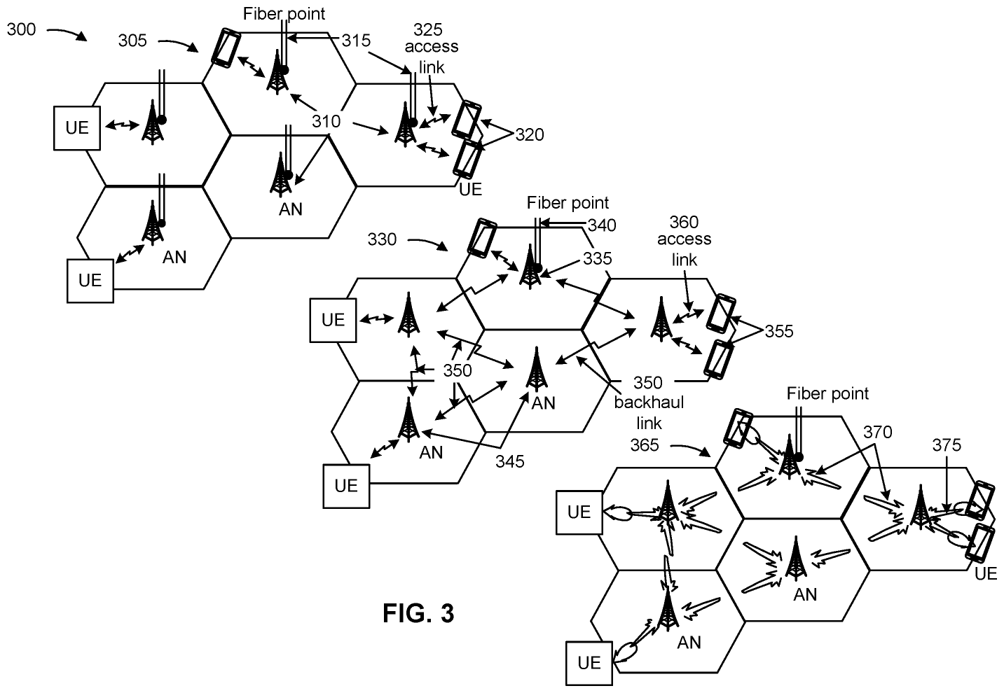

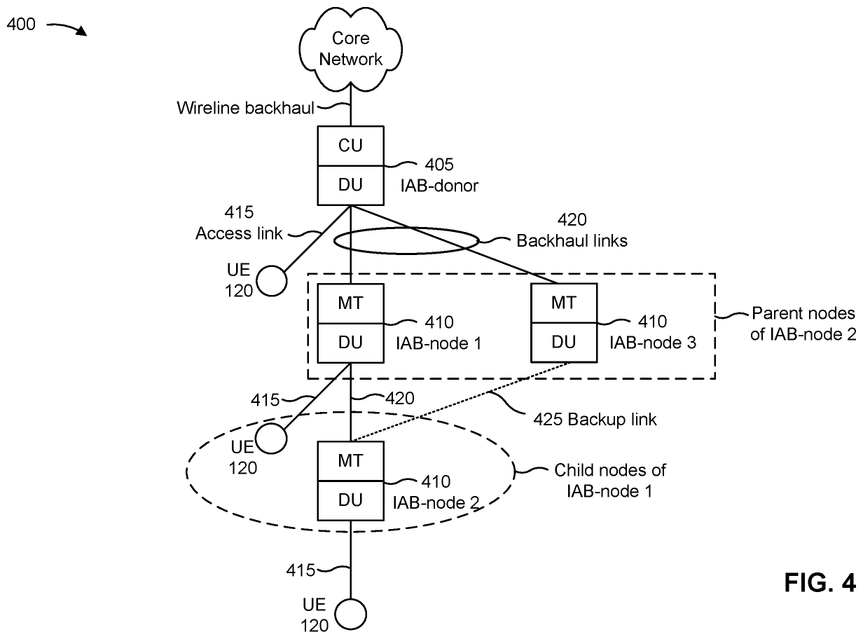

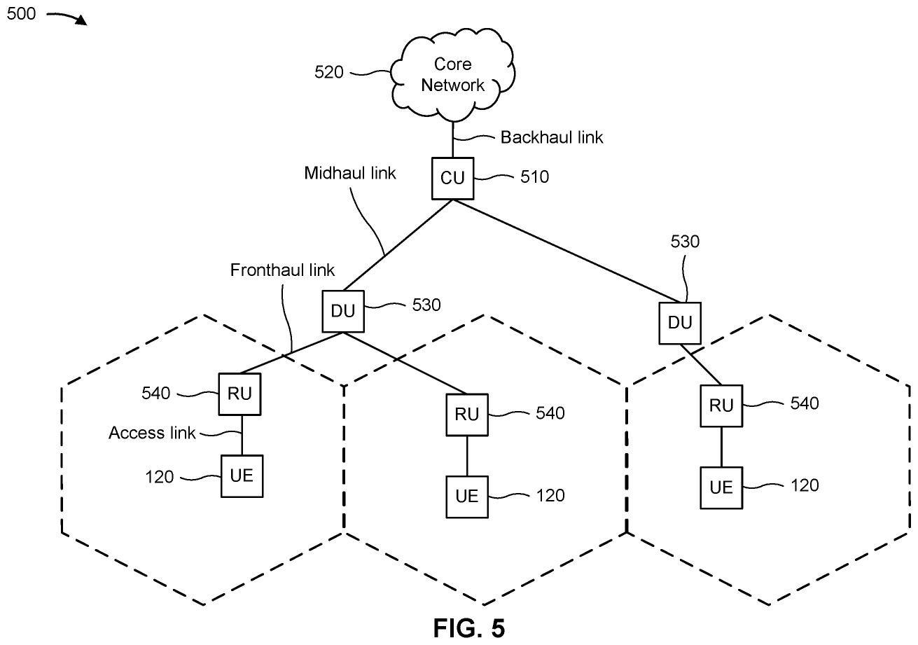

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although the base station 110 is shown as an integral unit in FIG. 1, aspects of the disclosure are not so limited. In some aspects, the functionality of the base station 110 may be disaggregated according to an integrated access and backhaul (IAB) architecture, which is described in more detail in connection with FIGS. 3 and 4, and/or according to an open radio access network (O-RAN) architecture, which is described in more detail in connection with FIG. 5. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the relay entity described elsewhere herein may correspond to the UE 120. In such aspects, the relay entity may include a communication manager 140. As described in more detail elsewhere herein, the communication manager 140 may establish a wireless communication session with a network entity associated with a visited public land mobile network (VPLMN), wherein the relay entity is configured to perform access node functions and UE functions, and wherein establishing the wireless communication session includes enabling wireless communication for both the access node functions and the UE functions via the VPLMN; and perform a relay service via the access node functions. Additionally, or alternatively, the communication manager 140 may perform one or more other operations described herein.

In some aspects, the network entity described elsewhere herein may correspond to the base station 110. In such aspects, the network entity may include a communication manager 150. As described in more detail elsewhere herein, the communication manager 150 may establish a wireless communication session with a relay entity, wherein the relay entity is configured to perform access node functions and UE functions, and wherein establishing the wireless communication session includes enabling wireless communication for both the access node functions and the UE functions via the VPLMN; and receive, from the relay entity, a communication associated with the access node functions of the relay entity. Additionally, or alternatively, the communication manager 150 may perform one or more other operations described herein.

As indicated above, FIG. 1 is provided as an example. Other examples may differ from what is described with regard to FIG. 1.

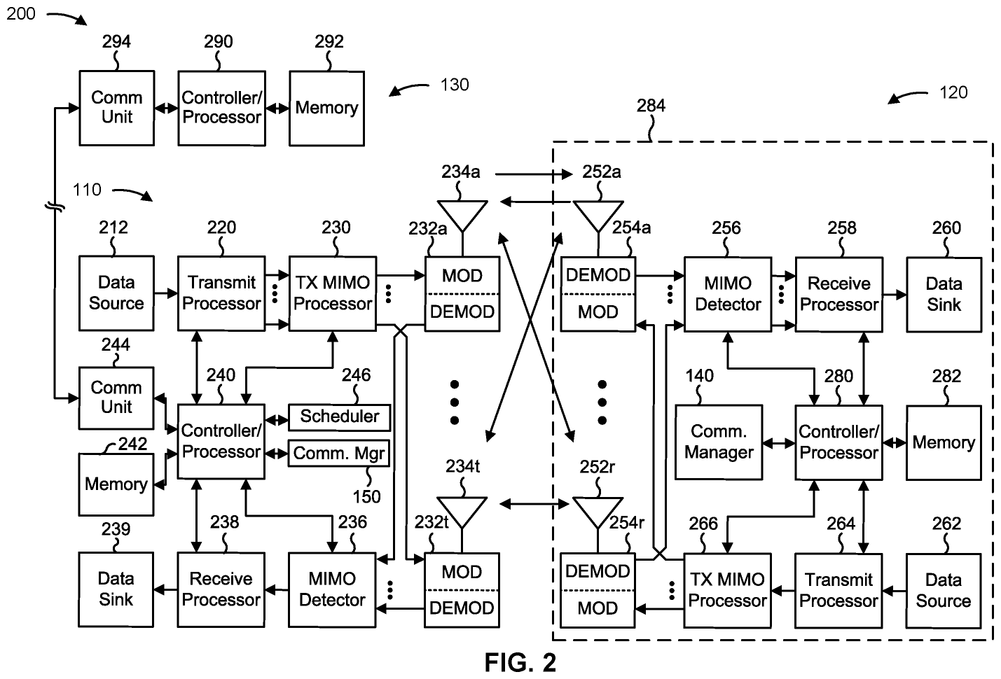

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

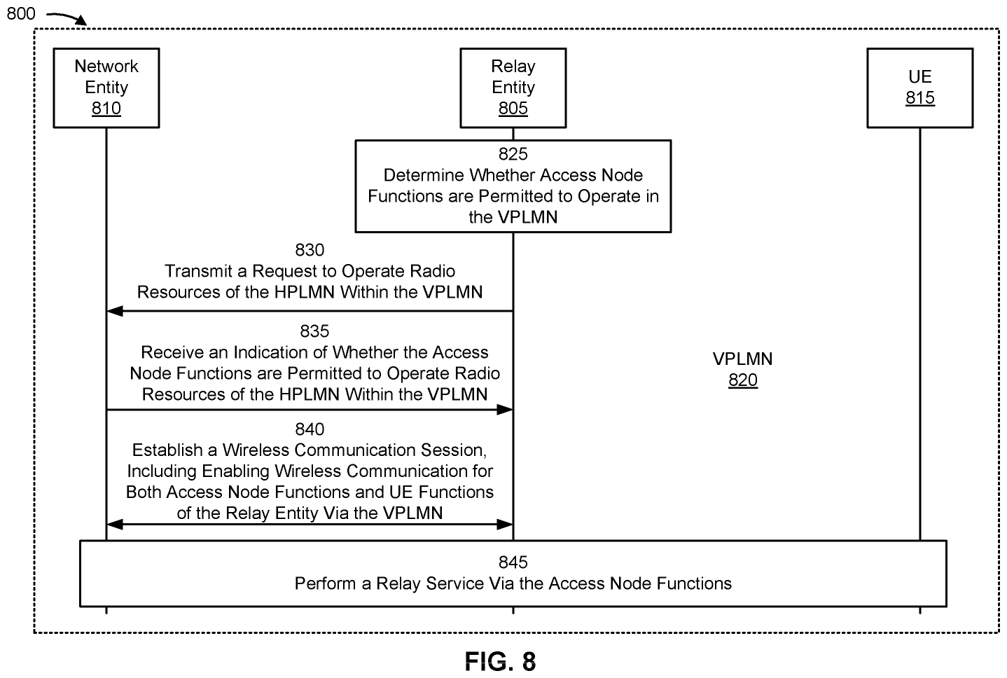

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

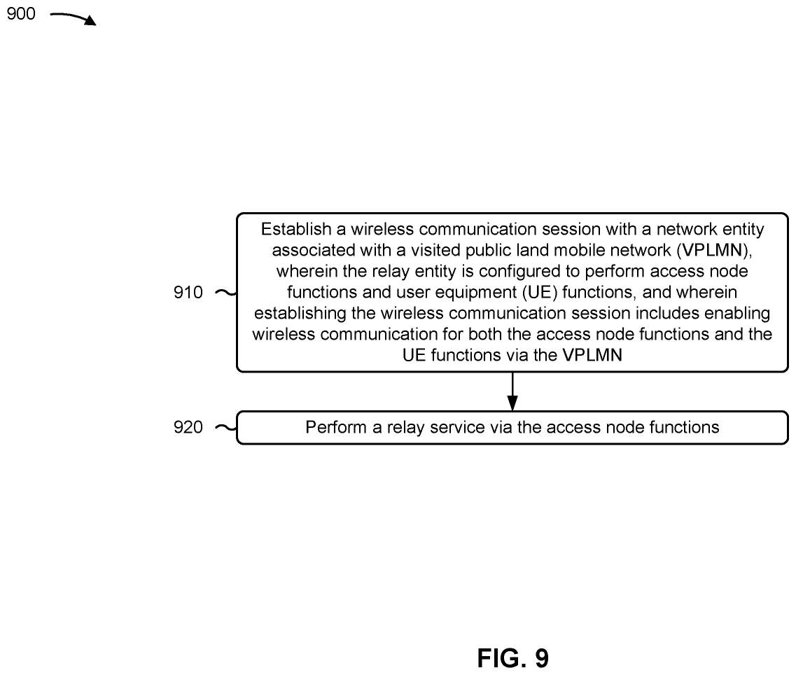

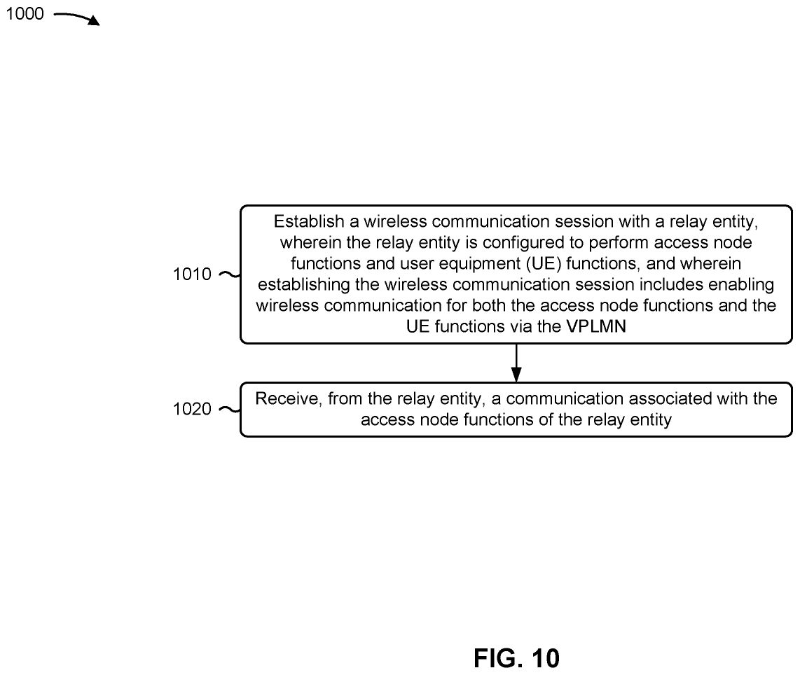

The controller/processor 240 of the base station 110, the controller/processor 280 of the UE 120, and/or any other component(s) of FIG. 2 may perform one or more techniques associated with wireless communication session for relay entities operating in a VPLMN, as described in more detail elsewhere herein. In some aspects, the network entity described herein is the base station 110, is included in the base station 110, or includes one or more components of the base station 110 shown in FIG. 2. In some aspects, the relay entity described herein is the UE 120, is included in the UE 120, or includes one or more components of the UE 120 shown in FIG. 2. The controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the relay entity includes means for establishing a wireless communication session with a network entity associated with a VPLMN, wherein the relay entity is configured to perform access node functions and UE functions, and wherein establishing the wireless communication session includes enabling wireless communication for both the access node functions and the UE functions via the VPLMN; and/or means for performing a relay service via the access node functions. In some aspects, the means for the relay entity to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for establishing a wireless communication session with a relay entity, wherein the relay entity is configured to perform access node functions and UE functions, and wherein establishing the wireless communication session includes enabling wireless communication for both the access node functions and the UE functions via the VPLMN; and/or means for receiving, from the relay entity, a communication associated with the access node functions of the relay entity. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating examples 300 of radio access networks, in accordance with the present disclosure.

As shown by reference number 305, a traditional (e.g., 3G, 4G, or LTE) radio access network may include multiple base stations 310 (e.g., access nodes (AN)), where each base station 310 communicates with a core network via a wired backhaul link 315, such as a fiber connection. A base station 310 may communicate with a UE 320 via an access link 325, which may be a wireless link. In some aspects, a base station 310 shown in FIG. 3 may be a base station 110 shown in FIG. 1. In some aspects, a UE 320 shown in FIG. 3 may be a UE 120 shown in FIG. 1.

As shown by reference number 330, a radio access network may include a wireless backhaul network, sometimes referred to as an IAB network. In an IAB network, at least one base station is an anchor base station 335 that communicates with a core network via a wired backhaul link 340, such as a fiber connection. An anchor base station 335 may also be referred to as an IAB donor (or IAB-donor). The IAB network may include one or more non-anchor base stations 345, sometimes referred to as relay base stations or IAB nodes (or IAB-nodes). The non-anchor base station 345 may communicate directly or indirectly with the anchor base station 335 via one or more backhaul links 350 (e.g., via one or more non-anchor base stations 345) to form a backhaul path to the core network for carrying backhaul traffic. Backhaul link 350 may be a wireless link. Anchor base station(s) 335 and/or non-anchor base station(s) 345 may communicate with one or more UEs 355 via access links 360, which may be wireless links for carrying access traffic. In some aspects, an anchor base station 335 and/or a non-anchor base station 345 shown in FIG. 3 may be a base station 110 shown in FIG. 1. In some aspects, a UE 355 shown in FIG. 3 may be a UE 120 shown in FIG. 1.

As shown by reference number 365, in some aspects, a radio access network that includes an IAB network may utilize millimeter wave technology and/or directional communications (e.g., beamforming) for communications between base stations and/or UEs (e.g., between two base stations, between two UEs, and/or between a base station and a UE). For example, wireless backhaul links 370 between base stations may use millimeter wave signals to carry information and/or may be directed toward a target base station using beamforming. Similarly, the wireless access links 375 between a UE and a base station may use millimeter wave signals and/or may be directed toward a target wireless node (e.g., a UE and/or a base station). In this way, inter-link interference may be reduced.

The configuration of base stations and UEs in FIG. 3 is shown as an example, and other examples are contemplated. For example, one or more base stations illustrated in FIG. 3 may be replaced by one or more UEs that communicate via a UE-to-UE access network (e.g., a peer-to-peer network or a device-to-device network). In this case, an anchor node may refer to a UE that is directly in communication with a base station (e.g., an anchor base station or a non-anchor base station).

As indicated above, FIG. 3 is provided as an example. Other examples may differ from what is described with regard to FIG. 3.

FIG. 4 is a diagram illustrating an example 400 of an IAB network architecture, in accordance with the present disclosure.

As shown in FIG. 4, an IAB network may include an IAB donor 405 (shown as IAB-donor) that connects to a core network via a wired connection (shown as a wireline backhaul). For example, an Ng interface of an IAB donor 405 may terminate at a core network. Additionally, or alternatively, an IAB donor 405 may connect to one or more devices of the core network that provide a core access and mobility management function (AMF). In some aspects, an IAB donor 405 may include a base station 110, such as an anchor base station, as described above in connection with 3. As shown, an IAB donor 405 may include a control unit (CU), which may perform access node controller (ANC) functions and/or AMF functions. The CU may configure a distributed unit (DU) of the IAB donor 405 and/or may configure one or more IAB nodes 410 (e.g., a mobile termination (MT) and/or a DU of an IAB node 410) that connect to the core network via the IAB donor 405. Thus, a CU of an IAB donor 405 may control and/or configure the entire IAB network that connects to the core network via the IAB donor 405, such as by using control messages and/or configuration messages (e.g., a radio resource control (RRC) configuration message or an F1 application protocol (F1-AP) message).

As further shown in FIG. 4, the IAB network may include IAB nodes 410 (shown as IAB-node 1, IAB-node 2, and IAB-node 3) that connect to the core network via the IAB donor 405. As shown, an IAB node 410 may include MT functions (also sometimes referred to as UE functions (UEF)) and may include DU functions (also sometimes referred to as access node functions (ANF)). The MT functions of an IAB node 410 (e.g., a child node) may be controlled and/or scheduled by another IAB node 410 (e.g., a parent node of the child node) and/or by an IAB donor 405. The DU functions of an IAB node 410 (e.g., a parent node) may control and/or schedule other IAB nodes 410 (e.g., child nodes of the parent node) and/or UEs 120. Thus, a DU may be referred to as a scheduling node or a scheduling component, and an MT may be referred to as a scheduled node or a scheduled component. In some aspects, an IAB donor 405 may include DU functions and not MT functions. That is, an IAB donor 405 may configure, control, and/or schedule communications of IAB nodes 410 and/or UEs 120. A UE 120 may include only MT functions, and not DU functions. That is, communications of a UE 120 may be controlled and/or scheduled by an IAB donor 405 and/or an IAB node 410 (e.g., a parent node of the UE 120).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor 405 or an IAB node 410, and a child node may be an IAB node 410 or a UE 120. Communications of an MT function of a child node may be controlled and/or scheduled by a parent node of the child node.

As further shown in FIG. 4, a link between a UE 120 (e.g., which only has MT functions, and not DU functions) and an IAB donor 405, or between a UE 120 and an IAB node 410, may be referred to as an access link 415. Access link 415 may be a wireless access link that provides a UE 120 with radio access to a core network via an IAB donor 405, and optionally via one or more IAB nodes 410. Thus, the network illustrated in 4 may be referred to as a multi-hop network or a wireless multi-hop network.

As further shown in FIG. 4, a link between an IAB donor 405 and an IAB node 410 or between two IAB nodes 410 may be referred to as a backhaul link 420. Backhaul link 420 may be a wireless backhaul link that provides an IAB node 410 with radio access to a core network via an IAB donor 405, and optionally via one or more other IAB nodes 410. In an IAB network, network resources for wireless communications (e.g., time resources, frequency resources, and/or spatial resources) may be shared between access links 415 and backhaul links 420. In some aspects, a backhaul link 420 may be a primary backhaul link or a secondary backhaul link (e.g., a backup backhaul link). In some aspects, a secondary backhaul link may be used if a primary backhaul link fails, becomes congested, and/or becomes overloaded, among other examples. For example, a backup link 425 between IAB-node 2 and IAB-node 3 may be used for backhaul communications if a primary backhaul link between IAB-node 2 and IAB-node 1 fails. As used herein, a node or a wireless node may refer to an IAB donor 405 or an IAB node 410.

As indicated above, FIG. 4 is provided as an example. Other examples may differ from what is described with regard to FIG. 4.

FIG. 5 is a diagram illustrating an example 500 of an O-RAN architecture, in accordance with the present disclosure. In some aspects, one or more of the wireless networks and/or radio access networks described herein (e.g., the wireless network 100, the radio access network shown by reference number 305, the IAB networks shown by reference numbers 330, 365, and 400, or a similar wireless network) may be further disaggregated according to the O-RAN architecture shown in FIG. 5.

As shown in FIG. 5, the O-RAN architecture may include a CU 510 that communicates with a core network 520 via a backhaul link. Furthermore, the CU 510 may communicate with one or more DUs 530 via respective midhaul links. The DUs 530 may each communicate with one or more radio units (RUs) 540 via respective fronthaul links, and the RUs 540 may each communicate with respective UEs 120 via radio frequency (RF) access links. The DUs 530 and the RUs 540 may also be referred to as O-RAN DUS (O-DUs) 530 and O-RAN RUs (O-RUs) 540, respectively.

In some aspects, the DUs 530 and the RUs 540 may be implemented according to a functional split architecture in which functionality of a base station 110 (e.g., an eNB or a gNB) is provided by a DU 530 and one or more RUs 540 that communicate over a fronthaul link. Accordingly, as described herein, a base station 110 may include a DU 530 and one or more RUs 540 that may be co-located or geographically distributed. In some aspects, the DU 530 and the associated RU(s) 540 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 530 may correspond to a logical unit that includes one or more base station functions to control the operation of one or more RUs 540. For example, in some aspects, the DU 530 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), RRC, and/or service data adaptation protocol (SDAP), may be hosted by the CU 510. The RU(s) 540 controlled by a DU 530 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 540 handle all over the air (OTA) communication with a UE 120, and real-time and non-real-time aspects of control and user plane communication with the RU(s) 540 are controlled by the corresponding DU 530, which enables the DU(s) 530 and the CU 510 to be implemented in a cloud-based RAN architecture.

As indicated above, FIG. 5 is provided as an example. Other examples may differ from what is described with regard to FIG. 5.

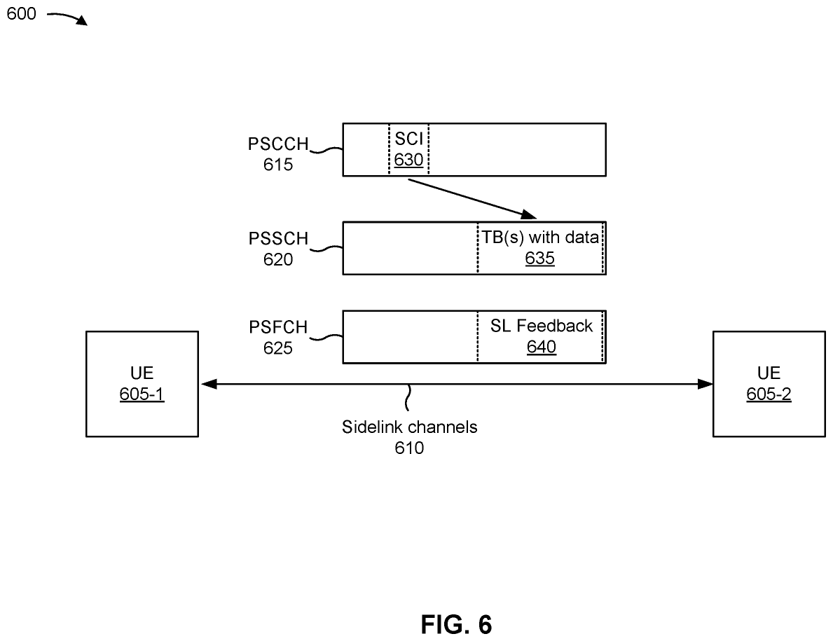

FIG. 6 is a diagram illustrating an example 600 of sidelink communications, in accordance with the present disclosure.

According to some aspects, on or more of the wireless networks and/or radio access network architectures described herein (e.g., the wireless network 100, the radio access network shown by reference number 305, the IAB networks shown by reference numbers 330, 365, and 400, the wireless network described in connection with reference number 500, or a similar wireless network) may be implemented by two UEs (e.g., UE 120) communicating in a sidelink. For example, as shown in FIG. 6, a first UE 605-1 may communicate with a second UE 605-2 (and one or more other UEs 605) via one or more sidelink channels 610. The UEs 605-1 and 605-2 may communicate using the one or more sidelink channels 610 for P2P communications, D2D communications, V2X communications (e.g., which may include V2V communications, V2I communications, and/or V2P communications) and/or mesh networking. In some aspects, the UEs 605 (e.g., UE 605-1 and/or UE 605-2) may correspond to one or more other UEs described elsewhere herein, such as UE 120. In some aspects, the one or more sidelink channels 610 may use a PC5 interface and/or may operate in a high frequency band (e.g., the 5.9 GHz band). Additionally, or alternatively, the UEs 605 may synchronize timing of transmission time intervals (TTIs) (e.g., frames, subframes, slots, or symbols) using global navigation satellite system (GNSS) timing.

As further shown in FIG. 6, the one or more sidelink channels 610 may include a physical sidelink control channel (PSCCH) 615, a physical sidelink shared channel (PSSCH) 620, and/or a physical sidelink feedback channel (PSFCH) 625. The PSCCH 615 may be used to communicate control information, similar to a physical downlink control channel (PDCCH) and/or a physical uplink control channel (PUCCH) used for cellular communications with a base station 110 via an access link or an access channel. The PSSCH 620 may be used to communicate data, similar to a physical downlink shared channel (PDSCH) and/or a physical uplink shared channel (PUSCH) used for cellular communications with a base station 110 via an access link or an access channel. For example, the PSCCH 615 may carry sidelink control information (SCI) 630, which may indicate various control information used for sidelink communications, such as one or more resources (e.g., time resources, frequency resources, and/or spatial resources) where a transport block (TB) 635 may be carried on the PSSCH 620. The TB 635 may include data. The PSFCH 625 may be used to communicate sidelink feedback 640, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 615, in some aspects, the SCI 630 may include multiple communications in different stages, such as a first stage SCI (SCI-1) and a second stage SCI (SCI-2). The SCI-1 may be transmitted on the PSCCH 615. The SCI-2 may be transmitted on the PSSCH 620. The SCI-1 may include, for example, an indication of one or more resources (e.g., time resources, frequency resources, and/or spatial resources) on the PSSCH 620, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 620, such as a HARQ process ID, a new data indicator (NDI), a source identifier, a destination identifier, and/or a channel state information (CSI) report trigger.

In some aspects, the one or more sidelink channels 610 may use resource pools. For example, a scheduling assignment (e.g., included in SCI 630) may be transmitted in sub-channels using specific resource blocks (RBs) across time. In some aspects, data transmissions (e.g., on the PSSCH 620) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 605 may operate using a sidelink transmission mode (e.g., Mode 1) where resource selection and/or scheduling is performed by a base station 110. For example, the UE 605 may receive a grant (e.g., in downlink control information (DCI) or in an RRC message, such as for configured grants) from the base station 110 for sidelink channel access and/or scheduling. In some aspects, a UE 605 may operate using a transmission mode (e.g., Mode 2) where resource selection and/or scheduling is performed by the UE 605 (e.g., rather than a base station 110). In some aspects, the UE 605 may perform resource selection and/or scheduling by sensing channel availability for transmissions. For example, the UE 605 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 605 may perform resource selection and/or scheduling using SCI 630 received in the PSCCH 615, which may indicate occupied resources and/or channel parameters. Additionally, or alternatively, the UE 605 may perform resource selection and/or scheduling by determining a channel busy ratio (CBR) associated with various sidelink channels, which may be used for rate control (e.g., by indicating a maximum number of resource blocks that the UE 605 can use for a particular set of subframes).

In the transmission mode where resource selection and/or scheduling is performed by a UE 605, the UE 605 may generate sidelink grants, and may transmit the grants in SCI 630. A sidelink grant may indicate, for example, one or more parameters (e.g., transmission parameters) to be used for an upcoming sidelink transmission, such as one or more resource blocks to be used for the upcoming sidelink transmission on the PSSCH 620 (e.g., for TBs 635), one or more subframes to be used for the upcoming sidelink transmission, and/or an MCS to be used for the upcoming sidelink transmission. In some aspects, a UE 605 may generate a sidelink grant that indicates one or more parameters for semi-persistent scheduling (SPS), such as a periodicity of a sidelink transmission. Additionally, or alternatively, the UE 605 may generate a sidelink grant for event-driven scheduling, such as for an on-demand sidelink message.

As indicated above, FIG. 6 is provided as an example. Other examples may differ from what is described with respect to FIG. 6.

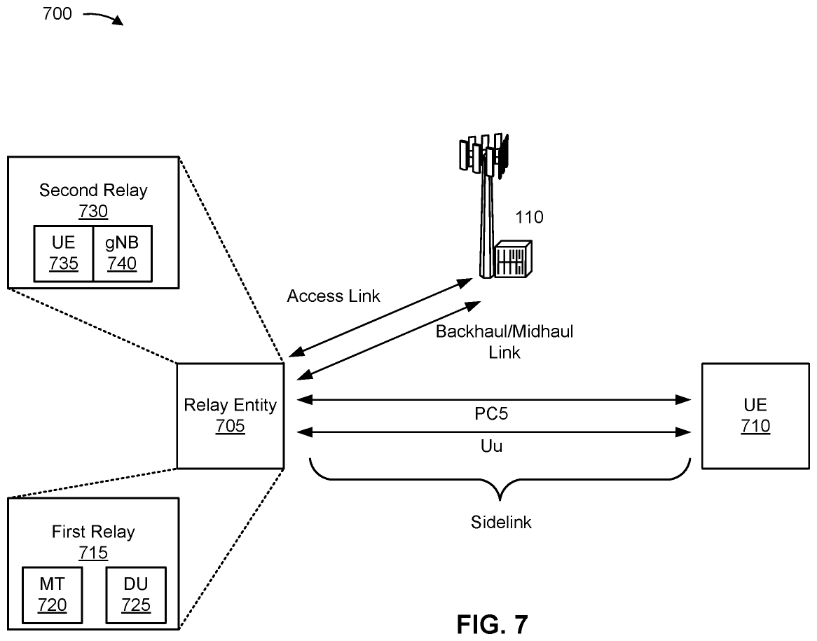

FIG. 7 is a diagram illustrating an example 700 of sidelink communications and access link communications, in accordance with the present disclosure.

As shown in FIG. 7, a relay entity 705 and a UE 710 may communicate with one another via a sidelink, as described above in connection with FIG. 6. As further shown, in some sidelink modes, a base station 110 may communicate with one or both the relay entity 705 or the UE 710 via an access link. For example, in FIG. 7 the base station communicates with the relay entity 705 via an access link. The relay entity 705 and/or the UE 710 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

In some aspects, a UE operating in the sidelink may act as a base station or similar network entity to relay communications from other UEs to enable communication by the other UEs with a core network or the like. In some aspects, when a UE operating in the sidelink acts as a base station or a similar network entity to relay communications from other UEs, the UE may be referred to as a mobile base station relay (MBSR). For example, as shown in FIG. 7, the relay entity 705 is in communication with the base station 110 (e.g., via the access link (e.g., Uu interface) for UE functions (sometimes referred to as IAB-UE functions) of the relay entity 705 an/or via a backhaul/midhaul link (e.g., F1 interface) for access node functions (sometimes referred to as IAB-DU functions) of the relay entity 705), but the UE 710 is not in direct communication with the base station (e.g., there is no access link or otherwise between the UE 710 and the base station 110). Thus, in some aspects, the relay entity 705 may act as a relay between the base station 110 and the UE 710 or other UEs. That is, the relay entity 705 may receive communications from the UE 710 intended for the base station 110 and relay the communications to the base station 110. Additionally, or alternatively, the relay entity 705 may receive communications from the base station 110 intended for the UE 710 and relay the communications to the UE 710.

For example, the relay entity 705 may be a vehicle-mounted relay (VMR), which may be mounted in a vehicle with a known path (such as a bus, a tram or a train, or the like), or may be mounted in a vehicle with a variable path (such as a taxi, an end-user car, or the like). VMRs and similar relay entities may receive wireless communication coverage from a stationary network entity (such as the base station 110 shown in FIG. 7, or a similar entity such as a CU 510, a DU 530, an RU 540, or the like), which may be referred to as a donor base station and/or a donor gNB and may provide coverage to neighboring UEs such as the UE 710 or the like. In aspects in which the relay entity is a VMR, the VMR may provide coverage to end-user UEs located within the corresponding vehicle (e.g., within the bus, tram, train, taxi, end-user car, or the like) and/or other UEs within a vicinity of the VMR.

In some aspects, the relay entity 705 may be configured according to an IAB architecture, and thus may include one or more of the components described in connection with FIGS. 3-5. In such aspects, the relay entity may be configured to perform access node functions (e.g., IAB-DU functions) and UE functions (e.g., IAB-UE functions), and thus may include an MT portion (sometimes referred to as an IAB-MT) that performs the UE functions and may include a DU portion (sometimes referred to as an IAB-DU) that performs the access node functions. For example, the relay entity 705 may be configured as a first relay 715, which may include an IAB-MT 720 and an IAB-DU 725. Moreover, in some aspects the donor base station (e.g., the base station 110 in FIG. 7) may also be a DU, and thus be in communication with a CU (not shown in FIG. 7) via an F1 interface. In such aspects, the first relay 715 may also be in communication with the CU via an F1 interface, and, more particularly, the IAB-DU 725 may be in communication with the CU via the F1 interface.

In some other aspects, the relay entity 705 may be configured according to a velcro architecture, in which the relay entity acts as a standalone base station and a UE. Put another way, rather than just acting as a DU as described in connection with the IAB architecture, the relay entity 705 may also include additional functionality such as the functionality performed by a CU of the IAB architecture. In such aspects, the relay entity 705 may be configured to perform access node functions and UE functions. Thus, the relay entity 705 may include a UE portion that performs the UE functions and may include a base station portion that performs the access node functions. For example, the relay entity 705 may be configured as a second relay 730, which may include a UE portion 735 and a base station portion 740. In such aspects, an N2/N3 interface between the relay and a macro cell may run over a user plane of a packet data unit (PDU) session established by UE portion 735 of the relay entity to a core network, which may be a core network of a public land mobile network (PLMN) used by the UE portion 735 of the relay entity, or which may be a core network of a different PLMN (e.g., a PLMN not being used by the UE portion 735).

Because the relay entity 705 may perform access node functions and UE functions, the relay entity 705 may establish a Uu interface and/or a PC5 interface with another UE. More particularly, in the example shown in FIG. 7, the relay entity 705 may establish a PC5 interface with the UE 710 via the IAB-MT 720 or the UE portion 735, respectively, and the relay entity 705 may establish a Uu interface with the UE 710 via the IAB-DU 725 or the base station portion 740, respectively. If the relay entity 705 thereafter leaves the coverage of a home PLMN (HPLMN) and enters the coverage of a VPLMN, the UE functions of the relay entity 705 may use certain legacy roaming procedures to connect to the VPLMN and thus continue to perform wireless communication. However, the access node functions of the relay entity 705 cannot use such legacy roaming procedures to connect to the VPLMN. Thus, the access node functions may not continue to operate while outside of the HPLMN, leading to reduced coverage for any UEs connected to the relay entity 705 via the Uu interface and even radio link failure for such UEs.

Some techniques and apparatuses described herein enable roaming for the access node functions (e.g., an IAB-DU 725, a base station portion 740, or the like) of a relay entity (e.g., the relay entity 705) such that the access node functions may establish a wireless communication session within a VPLMN and thus continue to provide coverage to one or more UEs over the Uu interface. More particularly, in some aspects, a relay entity may establish a wireless communication session with a network entity associated with a VPLMN (e.g., the base station 110 shown in FIG. 7 or a similar donor base station, donor DU, or the like). The relay entity 705 may be configured to perform access node functions (e.g., via an IAB-DU 725 and/or a base station portion 740) and UE functions (e.g., via an IAB-MT 720 and/or a UE portion 735), and establishing the wireless communication session may include enabling wireless communication for both the access node functions and the UE functions via the VPLMN. In aspects in which the access node functions are performed by an IAB-DU as part of an IAB architecture, the IAB-DU may connect to a donor base station in the VPLMN and may start operating as an IAB-DU in the VPLMN, and/or the IAB-DU may use the internet protocol (IP) connectivity provided by the link between an IAB-MT and the donor base station to maintain an F1 interface to a CU in the HPLMN. And in aspects in which the access node functions are performed by a base station portion of the relay entity as part of a velcro architecture, the base station portion may connect to an AMF associated with the donor base station in the VPLMN and may start operating as a base station in the VPLMN, and/or the base station portion of the relay entity may use the IP connectivity provided by the link between a UE portion of the relay entity and the donor base station to maintain an N2 interface to an AMF associated with the HPLMN. As a result, the relay entity may provide increased coverage including coverage outside of an HPLMN, thereby improving link quality and decreasing radio link failure for UEs connected to a relay entity.

As indicated above, FIG. 7 is provided as an example. Other examples may differ from what is described with respect to FIG. 7.

FIG. 8 is a diagram of an example 800 associated with establishing a wireless communication session for relay entities operating in a VPLMN, in accordance with the present disclosure. As shown in FIG. 8, a relay entity 805 (e.g., the relay entity 705) and a network entity 810 (e.g., a base station 110, a CU, a DU, and/or an RU) may communicate with one another. Moreover, the relay entity 805 may further communicate with a UE 815 (e.g., UE 120, UE 320, UE 355, UE 710, or the like), and the relay entity 805 may relay communications from the network entity 810 to the UE 815 and/or from the UE 815 to the network entity 810, as described in connection with FIG. 7. That is, the relay entity 805 may be configured to perform both access node functions and UE functions, as described. In some aspects, the network entity 810 may be a donor base station or donor gNB. In some aspects, the relay entity 805 and the network entity 810 may be part of a wireless network (e.g., the wireless network 100, the radio access network shown by reference number 305, the IAB networks shown by reference numbers 330, 365, and 400, or a similar wireless network). The relay entity 805 and the network entity 810 may have established a wireless connection prior to operations shown in FIG. 8. For example, in some aspects, UE functions of the relay entity 805 (e.g., the IAB-MT 720 and/or the UE portion 735 of the second relay 730) may have established a wireless connection with the network entity 810 prior to operations shown in FIG. 8, such as via legacy roaming procedures or the like.

As shown by reference number 825, in some aspects, upon entering the VPLMN 820 or otherwise, the relay entity 805 may determine whether the access node functions are permitted to operate in the VPLMN 820. In some aspects, the relay entity 805 may determine whether the access node functions are permitted to operate in the VPLMN 820 based at least in part on a provisioned list of preferred PLMNs and/or geographic areas. For example, the access node functions may be permitted to operate in some PLMNs (e.g., the VPLMN 820 and/or other PLMNs) but not other PLMNs, and the relay entity 805 may thus be provisioned with a list indicating in which PLMNs the access node functions are permitted to operate. Moreover, in some aspects, each of the preferred PLMNs and/or the geographic areas included in the list may include a corresponding priority value, and, when the relay entity 805 is within the coverage of multiple PLMNs, the relay entity 805 may select a PLMN based at least in part on the priority values. For example, the relay entity 805 may select the VPLMN 820 based at least in part on a priority value associated with the VPLMN 820. In some aspects, the relay entity 805 (e.g., the UE functions of the relay entity 805) may select a PLMN for wireless communication (e.g., the VPLMN 820) associated with a highest priority value and/or may select a PLMN for wireless communication based at least in part on whether the access node functions are permitted to operate in the VPLMN 820 (e.g., when the IAB-DU 725 is allowed to operate as an IAB-node in the VPLMN 820 and/or whether the base station portion 740 is allowed to operate as a base station in the VPLMN 820).

In some aspects, the determination indicated by reference number 825 may be based at least in part on signaling from the network entity 810, such as signaling received during registration of the UE functions of the relay entity 805 with the VPLMN 820. More particularly, during registration, the relay entity 805 may transmit, to the network entity 810, a request, associated with the UE functions, for the access node functions to operate in the VPLMN 820, and the relay entity 805 may then determine whether the access node functions are permitted to operate in the VPLMN 820 based at least in part on an indication received from the network entity 810. In some aspects, the indication received from the network entity 810 may be received in response to the request transmitted by the relay entity 805 for the access node functions to operate in the VPLMN 820, while, in some other aspects, the network entity 810 may provide the indication absent an explicit request from the relay entity (e.g., as a matter of course during a registration process associated with the UE functions or the like).

Moreover, in aspects in which the relay entity 805 transmits the request for the access node functions to operate in the VPLMN 820, an AMF or the like associated with the VPLMN 820 may accept the request and permit the access node functions to register with the VPLMN 820. Alternatively, an AMF or the like associated with the VPLMN 820 may reject the request for the access node functions to operate in the VPLMN 820, such as by transmitting a 5G mobility management (5GMM) cause value or the like. In some aspects, the 5GMM cause value may indicate that the relay entity 805 is “not allowed to operate as an IAB-node in this PLMN” or that the relay entity 805 is “not allowed to operate as a relay in this PLMN,” or the like. In such aspects, the rejection from the network entity 810 may trigger PLMN selection at the UE functions of the relay entity 805 (e.g., the IAB-MT 720 or the UE portion 735) to look for another VPLMN which allows operation as an IAB-node and/or as a relay node. In that regard, in some aspects, establishing a wireless communication session with the network entity 810 associated with the VPLMN 820 (as described in more detail below in connection with reference number 840) may be based at least in part on another VPLMN rejecting a request, associated with the UE functions of the relay entity 805, for the access node functions to operate in the other VPLMN.

As described in more detail below in connection with reference number 840, establishing a wireless communication session between the relay entity 805 and the network entity 810 may include the access node functions of the relay entity connecting to the network entity 810, or else the access node functions communicating with a HPLMN via a link between the UE functions of the relay entity 805 and the network entity 810 (e.g., using the IP connectivity provided by a link between the UE functions of the relay entity 805 and the network entity 810 to maintain an interface to the HPLMN). In aspects in which the access node functions communicate with the HPLMN via the link between the UE functions and the network entity 810, the relay entity may first need permission from the network entity 810 and/or the VPLMN 820 to operate radio resources of the HPLMN within VPLMN 820 coverage. Accordingly, as shown by reference number 830, the relay entity 805 (more particularly, the IAB-MT 720 and/or the UE portion 735) may transmit, to the network entity 810, a request to operate radio resources of the HPLMN within the VPLMN 820. Additionally, or alternatively, as shown by reference number 835, the relay entity 805 (more particularly, the IAB-MT 720 and/or the UE portion 735) may receive, from the network entity 810, an indication of whether the access node functions are permitted to operate radio resources of the HPLMN within the VPLMN 820.

As shown by reference number 840, the relay entity 805 may establish a wireless communication session with the network entity 810 associated with the VPLMN 820. Moreover, as described above, the relay entity 805 may be configured to perform access node functions (e.g., via the IAB-DU 725 and/or the base station portion 740) and UE functions (e.g., via the IAB-MT 720 and/or the UE portion 735), and establishing the wireless communication session include may include enabling wireless communication for both the access node functions and the UE functions via the VPLMN 820. In this way, the relay entity 805 may continue to service other UEs (e.g., UE 815) even though the relay entity 805 is within the VPLMN 820 (e.g., even though the relay entity 805 may be roaming).

As described above in connection with reference numbers 830 and 835, in some aspects establishing the wireless communication session with the network entity 810 associated with the VPLMN 820 includes the access node functions communicating with the HPLMN via the link between the UE functions and the network entity 810. In such aspects, the network entity 810 and/or the VPLMN 820 may effectively provide coverage extension for the HPLMN. Again, this may require that the relay entity 805 be permitted to operate radio resources of the HPLMN within coverage of the VPLMN 820, which, in some aspects, may be established via the communications described above in connection with reference numbers 835 and 840.

In some other aspects, establishing the wireless communication session with the network entity 810 associated with the VPLMN 820 may include establishing a connection between the access node functions and the network entity 810. For example, in some aspects the relay entity 805 may correspond to the first relay 715 described in connection with FIG. 7, and thus the UE functions may correspond to the IAB-MT 720 and the access node functions may correspond to the IAB-DU 725. In such aspects, establishing the wireless communication session with the network entity associated with the VPLMN may include establishing a connection between the IAB-DU and the network entity 810 (e.g., the IAB-DU may start operating as an IAB-DU in the VPLMN 820). For example, establishing a connection between the IAB-DU and the network entity 810 may include performing an IAB node integration procedure in the VPLMN 820. For example, the relay entity 805 may perform an IAB node integration procedure as specified in 3GPP Technical Specification (TS) 38.401 subclause 8.12.1 in the VPLMN 820.

In some aspects, the relay entity 805 may be provisioned with a list of certain parameters for performing the IAB node integration procedure. More particularly, in some aspects, performing the IAB node integration procedure in the VPLMN 820 may be based at least in part on a provisioned list including, for each of multiple preferred PLMNs or geographic areas, a data network name (DNN) and single network slice selection assistance information (S-NSSAI) pair associated with an operation and maintenance (OAM) PDU session, and a fully qualified domain name (FQDN) associated with an OAM server. Beneficially, the IAB node integration procedure (e.g., the IAB node integration procedure as specified in 3GPP TS 38.401 subclause 8.12.1 or the like) may not require an inter-PLMN connection (e.g., a connection between the HPLMN and the VPLMN 820).

In some other aspects, establishing a connection between the IAB-DU of the relay entity 805 and the network entity 810 may include performing an inter-donor full migration procedure. For example, a wireless communication session associated with the IAB-DU may be fully migrated from a donor base station or other network entity associated with the HPLMN to the network entity 810 associated with the VPLMN 820. In such aspects, there may be an established link (e.g., IP connectivity) between the donor base station or other network entity associated with the HPLMN and the network entity 810 associated with the VPLMN 820 in order to perform the inter-donor full migration procedure. Beneficially, the inter-donor full migration procedure may enable service continuity for UEs moving with the relay entity 805 (e.g., the UE 815).

In some other aspects, the relay entity 805 may correspond to the second relay 730 described in connection with FIG. 7, and thus the UE functions may correspond to the UE portion 735 of the second relay 730 and the access node functions may correspond to the base station portion 740 of the second relay. In such aspects, establishing the wireless communication session with the network entity 810 associated with the VPLMN 820 may include establishing a connection between the base station portion of the relay entity 805 and an AMF associated with the VPLMN 820 (e.g., the base station portion may start operating as base station in the VPLMN 820).

In some aspects, establishing a connection between the base station portion and the AMF associated with the VPLMN 820 may include performing an onboarding procedure in the VPLMN 820. In some aspects, the onboarding procedure in the VPLMN 820 may be based at least in part on a provisioned list of onboarding parameters. More particularly, performing the onboarding procedure in the VPLMN 820 may be based at least in part on a provisioned list including, for each of multiple preferred PLMNs or geographic areas, a DNN and S-NSSAI pair associated with an OAM PDU session, an FQDN associated with an OAM server, and a DNN and S-NSSAI pair to be used to establish a backhaul link. In such aspects, the UE functions of the relay entity 805 may establish an OAM PDU session using a DNN and an S-NSSAI associated with the VPLMN 820. Once the OAM PDU session is established, the UE portion of the relay entity 805 may receive, from the OAM server associated with the VPLMN 820, a configuration associated with the base station portion of the relay entity 805 (put another way, the relay entity 805 connects to the OAM server and downloads a base station configuration to operate in the VPLMN 820). Once configuration is complete, the relay entity 805 may establish an N2 interface between the base station portion of the relay entity 805 and an AMF associated with the VPLMN 820. Beneficially, the onboarding procedure in the VPLMN 820 may not require an inter-PLMN connection (e.g., a connection between the HPLMN and the VPLMN 820).

In some other aspects, establishing the wireless communication session with the network entity 810 associated with the VPLMN 820 may include performing an inter-PLMN handover procedure associated with the base station portion of the relay entity 805. In such aspects, an ongoing UE PDU session used for backhauling may be handed over to the VPLMN 820 by the HPLMN, with the relay entity 805 (and more particularly the base station portion of the relay entity 805) continuing to operate as a base station for the HPLMN. The inter-PLMN handover procedure may be based at least in part on a provisioned list of handover parameters. More particularly, performing the inter-PLMN handover procedure may be based at least in part on a provisioned list including, for each of multiple preferred PLMNs or geographic areas, a DNN and S-NSSAI pair associated with an OAM PDU session, an FQDN associated with an OAM server, and a DNN and S-NSSAI pair to be used to establish a backhaul link. The relay entity 805 (and, more particularly, the UE functions of the relay entity 805) may thus establish an OAM PDU session using a DNN and an S-NSSAI associated with the VPLMN 820. Once the OAM PDU session is established, the UE portion of the relay entity 805 may receive, from the OAM server associated with the VPLMN 820, a configuration associated with the base station portion of the relay entity 805 (put another way, the relay entity 805 may connect to the OAM server and download a base station configuration to operate in the VPLMN 820).

Once configuration is complete, the relay entity 805 may, based at least in part on the provisioned list of handover parameters, establish a PDU session for backhauling in the VPLMN 820, and may establish an N2 interface between the base station portion of the relay entity 805 and an AMF associated with the VPLMN 820. Accordingly, the base station portion of the relay entity 805 may simultaneously act as a base station for the HPLMN and a base station for the VPLMN 820. Any UEs connected to the relay entity 805 (e.g., UE 815) may thus be handed over, by the relay entity 805, from the HPLMN to the VPLMN 820 (e.g., UEs connected to the relay entity 805 are handed over from the base station instance operating for the HPLMN to the base station instance operating for the VPLMN 820). After the UE handover is complete, the relay entity 805 may stop operating as a base station for the HPLMN. That is, the relay entity 805 may end a wireless communication session with the HPLMN based at least in part on handing over the UEs connected to the relay entity 805 from the HPLMN to the VPLMN 820. Additionally, or alternatively, the relay entity 805 may also release a PDU session used for backhauling for the HPLMN. Beneficially, the inter-PLMN handover procedure may enable service continuity for UEs moving with the relay entity 805 (e.g., the UE 815).

As shown by reference number 845, once the relay entity 805 has established the wireless communication session with the network entity 810, the relay entity 805 may perform a relay service via the access node functions of the relay entity 805 (e.g., via the IAB-DU or the base station portion of the relay entity 805). For example, the network entity 810 may receive, from the relay entity 805, a communication associated with the access node functions of the relay entity 805. As described above in connection with FIG. 7, in some aspects, performing a relay service via the access node functions may include receiving communications from the UE 815 intended for the network entity 810, and relaying the communications to the network entity 810. Additionally, or alternatively, performing a relay service via the access node functions may include receiving communications from the network entity 810 intended for the UE 815, and relaying the communications to the UE 815. In this regard, relay entities, such as VMRs or the like, may beneficially continue to provide relay services within a VPLMN, thereby providing increased coverage and decreased radio link failure for connected UEs.

As indicated above, FIG. 8 is provided as an example. Other examples may differ from what is described with regard to FIG. 8.

FIG. 9 is a diagram illustrating an example process 900 performed, for example, by a relay entity, in accordance with the present disclosure. Example process 900 is an example where the relay entity (e.g., relay entity 805) performs operations associated with wireless communication sessions for relay entities operating in a VPLMN.

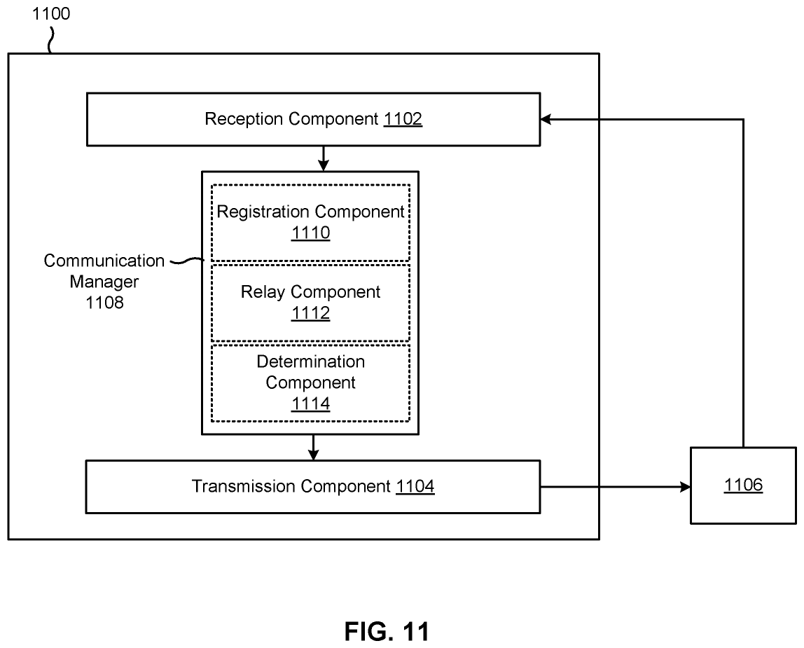

As shown in FIG. 9, in some aspects, process 900 may include establishing a wireless communication session with a network entity (e.g., network entity 810) associated with a VPLMN (e.g., VPLMN 820), wherein the relay entity is configured to perform access node functions and UE functions, and wherein establishing the wireless communication session includes enabling wireless communication for both the access node functions and the UE functions via the VPLMN (block 910). For example, the relay entity (e.g., using communication manager 1108 and/or registration component 1110, depicted in FIG. 11) may establish a wireless communication session with a network entity associated with a VPLMN, wherein the relay entity is configured to perform access node functions and UE functions, and wherein establishing the wireless communication session includes enabling wireless communication for both the access node functions and the UE functions via the VPLMN, as described above.

As further shown in FIG. 9, in some aspects, process 900 may include performing a relay service via the access node functions (block 920). For example, the relay entity (e.g., using communication manager 1108 and/or relay component 1112, depicted in FIG. 11) may perform a relay service via the access node functions, as described above.

Process 900 may include additional aspects, such as any single aspect or any combination of aspects described below and/or in connection with one or more other processes described elsewhere herein.

In a first aspect, process 900 includes determining whether the access node functions are permitted to operate in the VPLMN.

In a second aspect, alone or in combination with the first aspect, determining whether the access node functions are permitted to operate in the VPLMN is based at least in part on at least one of a provisioned list of preferred PLMNs, or a provisioned list of PLMNs in which the access node functions are not permitted to operate.

In a third aspect, alone or in combination with one or more of the first and second aspects, each of the at least one of the preferred PLMNs includes a corresponding priority value.

In a fourth aspect, alone or in combination with one or more of the first through third aspects, process 900 includes selecting the VPLMN based at least in part on a priority value associated with the VPLMN.

In a fifth aspect, alone or in combination with one or more of the first through fourth aspects, determining whether the access node functions are permitted to operate in the VPLMN is based at least in part on an indication received from the network entity.

In a sixth aspect, alone or in combination with one or more of the first through fifth aspects, the indication received from the network entity is received in response to a request, associated with the UE functions, for the access node functions to operate in the VPLMN.

In a seventh aspect, alone or in combination with one or more of the first through sixth aspects, establishing the wireless communication session with the network entity associated with the VPLMN is based at least in part on another VPLMN rejecting a request, associated with the UE functions, for the access node functions to operate in the other VPLMN.

In an eighth aspect, alone or in combination with one or more of the first through seventh aspects, establishing the wireless communication session with the network entity associated with the VPLMN includes the access node functions communicating with an HPLMN via a link between the UE functions and the network entity.

In a ninth aspect, alone or in combination with one or more of the first through eighth aspects, the relay entity determines whether the access node functions are permitted to operate radio resources of the HPLMN within the VPLMN based at least in part on at least one of a provisioned list of preferred PLMNs, or a provisioned list of PLMNs in which the access node functions are not permitted to operate.

In a tenth aspect, alone or in combination with one or more of the first through ninth aspects, each of the preferred PLMNs includes a corresponding priority value.

In an eleventh aspect, alone or in combination with one or more of the first through tenth aspects, process 900 includes selecting the VPLMN based at least in part on a priority value associated with the VPLMN.

In a twelfth aspect, alone or in combination with one or more of the first through eleventh aspects, process 900 includes transmitting, to the network entity, a request to operate radio resources of the HPLMN within the VPLMN.

In a thirteenth aspect, alone or in combination with one or more of the first through twelfth aspects, determining whether the access node functions are permitted to operate radio resources of the HPLMN within the VPLMN is based at least in part on an indication received from the network entity.

In a fourteenth aspect, alone or in combination with one or more of the first through thirteenth aspects, the indication received from the network entity is received in response to the request to operate radio resources of the HPLMN within the VPLMN.

In a fifteenth aspect, alone or in combination with one or more of the first through fourteenth aspects, establishing the wireless communication session with the network entity associated with the VPLMN is based at least in part on another VPLMN rejecting a request, associated with the UE functions, for the access node functions to operate radio resources of the HPLMN within the other VPLMN.

In a sixteenth aspect, alone or in combination with one or more of the first through fifteenth aspects, the access node functions are associated with an IAB-DU.

In a seventeenth aspect, alone or in combination with one or more of the first through sixteenth aspects, establishing the wireless communication session with the network entity associated with the VPLMN includes establishing a connection between the IAB-DU and the network entity.

In an eighteenth aspect, alone or in combination with one or more of the first through seventeenth aspects, establishing the wireless communication session with the network entity associated with the VPLMN includes performing an IAB node integration procedure in the VPLMN associated with the IAB-DU.

In a nineteenth aspect, alone or in combination with one or more of the first through eighteenth aspects, performing the IAB node integration procedure in the VPLMN is based at least in part on a provisioned list including, for each of multiple preferred PLMNs, a DNN and S-NSSAI pair associated with an OAM PDU session, and an FQDN associated with an OAM server.

In a twentieth aspect, alone or in combination with one or more of the first through nineteenth aspects, establishing the wireless communication session with the network entity associated with the VPLMN includes performing an inter-donor full migration procedure associated with the IAB-DU.

In a twenty-first aspect, alone or in combination with one or more of the first through twentieth aspects, the access node functions are associated with a base station portion of the relay entity.

In a twenty-second aspect, alone or in combination with one or more of the first through twenty-first aspects, establishing the wireless communication session with the network entity associated with the VPLMN includes establishing a connection between the base station portion of the relay entity and an AMF associated with the VPLMN.

In a twenty-third aspect, alone or in combination with one or more of the first through twenty-second aspects, establishing the wireless communication session with the network entity associated with the VPLMN includes performing an onboarding procedure in the VPLMN associated with the base station portion of the relay entity.

In a twenty-fourth aspect, alone or in combination with one or more of the first through twenty-third aspects, performing the onboarding procedure in the VPLMN is based at least in part on a provisioned list including, for each of multiple preferred PLMNs, a DNN and S-NSSAI pair associated with an OAM PDU session, an FQDN associated with an OAM server, and a DNN and S-NSSAI pair to be used to establish a backhaul link.

In a twenty-fifth aspect, alone or in combination with one or more of the first through twenty-fourth aspects, performing the onboarding procedure in the VPLMN is based at least in part on the UE functions establishing an OAM PDU session using a DNN and an S-NSSAI associated with the VPLMN.

In a twenty-sixth aspect, alone or in combination with one or more of the first through twenty-fifth aspects, process 900 includes receiving, from an OAM server associated with the VPLMN, a configuration associated with the base station portion of the relay entity.

In a twenty-seventh aspect, alone or in combination with one or more of the first through twenty-sixth aspects, process 900 includes, based at least in part on receiving the configuration associated with the base station portion of the relay entity, establishing an N2 interface between the base station portion of the relay entity and an AMF associated with the VPLMN.

In a twenty-eighth aspect, alone or in combination with one or more of the first through twenty-seventh aspects, establishing the wireless communication session with the network entity associated with the VPLMN includes performing an inter-PLMN handover procedure associated with the base station portion of the relay entity.

In a twenty-ninth aspect, alone or in combination with one or more of the first through twenty-eighth aspects, performing the inter-PLMN handover procedure includes handing over a UE PDU session from an HPLMN to the VPLMN.

In a thirtieth aspect, alone or in combination with one or more of the first through twenty-ninth aspects, performing the inter-PLMN handover procedure is based at least in part on a provisioned list including, for each of multiple preferred PLMNs, a DNN and S-NSSAI pair associated with an OAM PDU session, an FQDN associated with an OAM server, and a DNN and S-NSSAI pair to be used to establish a backhaul link.

In a thirty-first aspect, alone or in combination with one or more of the first through thirtieth aspects, performing the inter-PLMN handover procedure is based at least in part on the UE functions establishing an OAM PDU session using a DNN and an S-NSSAI associated with the VPLMN.

In a thirty-second aspect, alone or in combination with one or more of the first through thirty-first aspects, process 900 includes receiving, from an OAM server associated with the VPLMN, a configuration associated with the base station portion of the relay entity.

In a thirty-third aspect, alone or in combination with one or more of the first through thirty-second aspects, process 900 includes, based at least in part on the provisioned list, establishing a PDU session for backhauling in the VPLMN.

In a thirty-fourth aspect, alone or in combination with one or more of the first through thirty-third aspects, process 900 includes, based at least in part on receiving the configuration associated with the base station portion of the relay entity, establishing an N2 interface between the base station portion of the relay entity and an AMF associated with the VPLMN.

In a thirty-fifth aspect, alone or in combination with one or more of the first through thirty-fourth aspects, process 900 includes handing over, by the relay entity, UEs connected to the relay entity from the HPLMN to the VPLMN.

In a thirty-sixth aspect, alone or in combination with one or more of the first through thirty-fifth aspects, process 900 includes ending a wireless communication session with the HPLMN based at least in part on handing over the UEs connected to the relay entity from the HPLMN to the VPLMN.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., network entity 810) performs operations associated with wireless communication sessions for relay entities operating in a VPLMN.

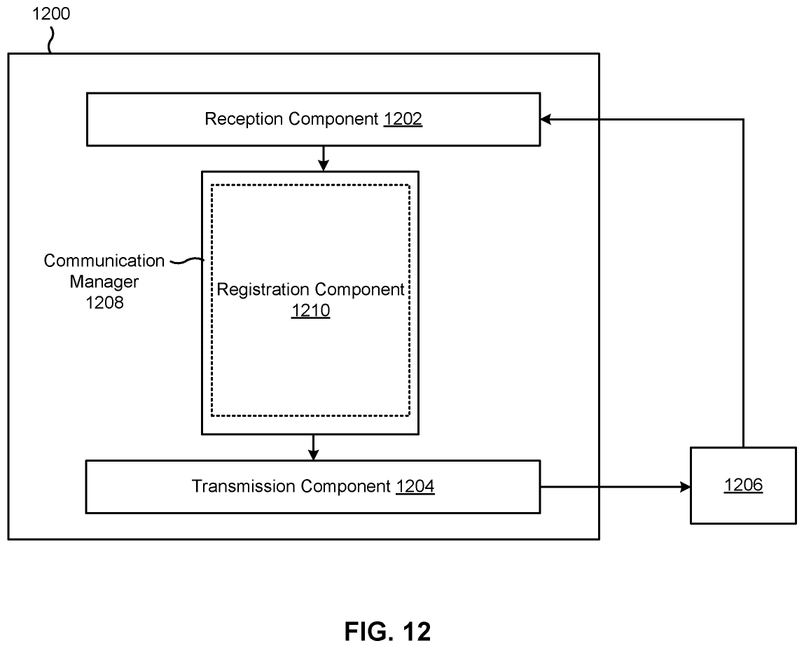

As shown in FIG. 10, in some aspects, process 1000 may include establishing a wireless communication session with a relay entity (e.g., relay entity 805), wherein the relay entity is configured to perform access node functions and UE functions, and wherein establishing the wireless communication session includes enabling wireless communication for both the access node functions and the UE functions via the VPLMN (block 1010). For example, the network entity (e.g., using communication manager 1208 and/or registration component 1210, depicted in FIG. 12) may establish a wireless communication session with a relay entity, wherein the relay entity is configured to perform access node functions and UE functions, and wherein establishing the wireless communication session includes enabling wireless communication for both the access node functions and the UE functions via the VPLMN, as described above.

As further shown in FIG. 10, in some aspects, process 1000 may include receiving, from the relay entity, a communication associated with the access node functions of the relay entity (block 1020). For example, the network entity (e.g., using communication manager 1208 and/or reception component 1202, depicted in FIG. 12) may receive, from the relay entity, a communication associated with the access node functions of the relay entity, as described above.

Process 1000 may include additional aspects, such as any single aspect or any combination of aspects described below and/or in connection with one or more other processes described elsewhere herein.

In a first aspect, process 1000 includes transmitting, to the relay entity, an indication of whether the access node functions are permitted to operate in the VPLMN.

In a second aspect, alone or in combination with the first aspect, the indication is transmitted in response to a request, associated with the UE functions of the relay entity, for the access node functions to operate in the VPLMN.

In a third aspect, alone or in combination with one or more of the first and second aspects, establishing the wireless communication session with the relay entity includes the access node functions communicating with an HPLMN via a link between the UE functions and the network entity.

In a fourth aspect, alone or in combination with one or more of the first through third aspects, process 1000 includes receiving, from the relay entity, a request to operate radio resources of the HPLMN within the VPLMN.

In a fifth aspect, alone or in combination with one or more of the first through fourth aspects, process 1000 includes transmitting, to the relay entity, an indication of whether the access node functions are permitted to operate radio resources of the HPLMN within the VPLMN.

In a sixth aspect, alone or in combination with one or more of the first through fifth aspects, the access node functions are associated with an IAB-DU.

In a seventh aspect, alone or in combination with one or more of the first through sixth aspects, establishing the wireless communication session with the relay entity includes establishing a connection between the IAB-DU and the network entity.

In an eighth aspect, alone or in combination with one or more of the first through seventh aspects, establishing the wireless communication session with the relay entity includes performing an IAB node integration procedure in the VPLMN associated with the IAB-DU.

In a ninth aspect, alone or in combination with one or more of the first through eighth aspects, performing the IAB node integration procedure in the VPLMN is based at least in part on a provisioned list including, for each of multiple preferred PLMNs, a DNN and S-NSSAI pair associated with an OAM PDU session, and an FQDN associated with an OAM server.

In a tenth aspect, alone or in combination with one or more of the first through ninth aspects, establishing the wireless communication session with the relay entity includes performing an inter-donor full migration procedure associated with the IAB-DU.

In an eleventh aspect, alone or in combination with one or more of the first through tenth aspects, the access node functions are associated with a base station portion of the relay entity.

In a twelfth aspect, alone or in combination with one or more of the first through eleventh aspects, establishing the wireless communication session with the relay entity includes establishing a connection between the base station portion of the relay entity and an AMF associated with the VPLMN.

In a thirteenth aspect, alone or in combination with one or more of the first through twelfth aspects, establishing the wireless communication session with the relay entity includes performing an onboarding procedure in the VPLMN associated with the base station portion of the relay entity.

In a fourteenth aspect, alone or in combination with one or more of the first through thirteenth aspects, performing the onboarding procedure in the VPLMN is based at least in part on a provisioned list including, for each of multiple preferred PLMNs, a DNN and S-NSSAI pair associated with an OAM PDU session, an FQDN associated with an OAM server, and a DNN and S-NSSAI pair to be used to establish a backhaul link.

In a fifteenth aspect, alone or in combination with one or more of the first through fourteenth aspects, performing the onboarding procedure in the VPLMN is based at least in part on the UE functions establishing an OAM PDU session using a DNN and an S-NSSAI associated with the VPLMN.

In a sixteenth aspect, alone or in combination with one or more of the first through fifteenth aspects, process 1000 includes transmitting, to the relay entity, a configuration associated with the base station portion of the relay entity.

In a seventeenth aspect, alone or in combination with one or more of the first through sixteenth aspects, process 1000 includes, based at least in part on transmitting the configuration associated with the base station portion of the relay entity, establishing an N2 interface between the base station portion of the relay entity and an AMF associated with the VPLMN.

In an eighteenth aspect, alone or in combination with one or more of the first through seventeenth aspects, establishing the wireless communication session with the relay entity includes performing an inter-PLMN handover procedure associated with the base station portion of the relay entity.

In a nineteenth aspect, alone or in combination with one or more of the first through eighteenth aspects, performing the inter-PLMN handover procedure includes handing over a UE PDU session from an HPLMN to the VPLMN.

In a twentieth aspect, alone or in combination with one or more of the first through nineteenth aspects, performing the inter-PLMN handover procedure is based at least in part on a provisioned list including, for each of multiple preferred PLMNs, a DNN and S-NSSAI pair associated with an OAM PDU session, an FQDN associated with an OAM server, and a DNN and S-NSSAI pair associated with a backhaul link.

In a twenty-first aspect, alone or in combination with one or more of the first through twentieth aspects, performing the inter-PLMN handover procedure is based at least in part on the UE functions establishing an OAM PDU session using a DNN and an S-NSSAI associated with the VPLMN.

In a twenty-second aspect, alone or in combination with one or more of the first through twenty-first aspects, process 1000 includes transmitting, to the relay entity, a configuration associated with the base station portion of the relay entity.

In a twenty-third aspect, alone or in combination with one or more of the first through twenty-second aspects, process 1000 includes, based at least in part on the provisioned list, establishing a PDU session for backhauling in the VPLMN.

In a twenty-fourth aspect, alone or in combination with one or more of the first through twenty-third aspects, process 1000 includes, based at least in part on transmitting the configuration associated with the base station portion of the relay entity, establishing an N2 interface between the base station portion of the relay entity and an AMF associated with the VPLMN.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a relay entity (e.g., relay entity 805), or a relay entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108 (e.g., communication manager 140). The communication manager 1108 may include one or more of a registration component 1110, a relay component 1112, or a determination component 1114, among other examples.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE 120 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE 120 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE 120 described in connection with FIG. 2. In some aspects, the transmission component 1104 may be co-located with the reception component 1102 in a transceiver.

The registration component 1110 may establish a wireless communication session with a network entity associated with a VPLMN, wherein the relay entity is configured to perform access node functions and UE functions, and wherein establishing the wireless communication session includes enabling wireless communication for both the access node functions and the UE functions via the VPLMN. The relay component 1112 may perform a relay service via the access node functions.

The determination component 1114 may determine whether the access node functions are permitted to operate in the VPLMN. The determination component 1114 may select the VPLMN based at least in part on a priority value associated with the VPLMN. The determination component 1114 may select the VPLMN based at least in part on a priority value associated with the VPLMN.

The transmission component 1104 may transmit, to the network entity, a request to operate radio resources of the HPLMN within the VPLMN. The reception component 1102 may receive, from an OAM server associated with the VPLMN, a configuration associated with the base station portion of the relay entity.

The registration component 1110 may hand over UEs connected to the relay entity from the HPLMN to the VPLMN. The registration component 1110 may end a wireless communication session with the HPLMN based at least in part on handing over the UEs connected to the relay entity from the HPLMN to the VPLMN.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity (e.g., network entity 810), or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may include a registration component 1210 among other examples.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the base station 110 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station 110 described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station 110 described in connection with FIG. 2. In some aspects, the transmission component 1204 may be co-located with the reception component 1202 in a transceiver.

The registration component 1210 may establish a wireless communication session with a relay entity, wherein the relay entity is configured to perform access node functions and UE functions, and wherein establishing the wireless communication session includes enabling wireless communication for both the access node functions and the UE functions via the VPLMN. The reception component 1202 may receive, from the relay entity, a communication associated with the access node functions of the relay entity.

The transmission component 1204 may transmit, to the relay entity, an indication of whether the access node functions are permitted to operate in the VPLMN. The reception component 1202 may receive, from the relay entity, a request to operate radio resources of the HPLMN within the VPLMN. The transmission component 1204 may transmit, to the relay entity, an indication of whether the access node functions are permitted to operate radio resources of the HPLMN within the VPLMN.

The transmission component 1204 may transmit, to the relay entity, a configuration associated with the base station portion of the relay entity.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a relay entity, comprising: establishing a wireless communication session with a network entity associated with a VPLMN, wherein the relay entity is configured to perform access node functions and UE functions, and wherein establishing the wireless communication session includes enabling wireless communication for both the access node functions and the UE functions via the VPLMN; and performing a relay service via the access node functions.

Aspect 2: The method of Aspect 1, further comprising determining whether the access node functions are permitted to operate in the VPLMN.

Aspect 3: The method of Aspect 2, wherein determining whether the access node functions are permitted to operate in the VPLMN is based at least in part on at least one of a provisioned list of preferred PLMNs, or a provisioned list of PLMNs in which the access node functions are not permitted to operate.

Aspect 4: The method of Aspect 3, wherein each of the preferred PLMNs includes a corresponding priority value.

Aspect 5: The method of Aspect 4, further comprising selecting the VPLMN based at least in part on a priority value associated with the VPLMN.

Aspect 6: The method of any of Aspects 2-5, wherein determining whether the access node functions are permitted to operate in the VPLMN is based at least in part on an indication received from the network entity.

Aspect 7: The method of Aspect 6, wherein the indication received from the network entity is received in response to a request, associated with the UE functions, for the access node functions to operate in the VPLMN.

Aspect 8: The method of any of Aspects 6-7, wherein establishing the wireless communication session with the network entity associated with the VPLMN is based at least in part on another VPLMN rejecting a request, associated with the UE functions, for the access node functions to operate in the other VPLMN.

Aspect 9: The method of any of Aspects 1-8, wherein establishing the wireless communication session with the network entity associated with the VPLMN includes the access node functions communicating with an HPLMN via a link between the UE functions and the network entity.

Aspect 10: The method of Aspect 9, wherein the relay entity determines whether the access node functions are permitted to operate radio resources of the HPLMN within the VPLMN at least in part on at least one of a provisioned list of preferred PLMNs, or a provisioned list of PLMNs in which the access node functions are not permitted to operate.

Aspect 11: The method of Aspect 10, wherein each of the preferred PLMNs includes a corresponding priority value.

Aspect 12: The method of Aspect 11, further comprising selecting the VPLMN based at least in part on a priority value associated with the VPLMN.

Aspect 13: The method of any of Aspects 9-12, further comprising transmitting, to the network entity, a request to operate radio resources of the HPLMN within the VPLMN.

Aspect 14: The method of Aspect 13, wherein determining whether the access node functions are permitted to operate radio resources of the HPLMN within the VPLMN is based at least in part on an indication received from the network entity.

Aspect 15: The method of Aspect 14, wherein the indication received from the network entity is received in response to the request to operate radio resources of the HPLMN within the VPLMN.

Aspect 16: The method of any of Aspects 14-15, wherein establishing the wireless communication session with the network entity associated with the VPLMN is based at least in part on another VPLMN rejecting a request, associated with the UE functions, for the access node functions to operate radio resources of the HPLMN within the other VPLMN.

Aspect 17: The method of any of Aspects 1-16, wherein the access node functions are associated with an IAB-DU.

Aspect 18: The method of Aspect 17, wherein establishing the wireless communication session with the network entity associated with the VPLMN includes establishing a connection between the IAB-DU and the network entity.

Aspect 19: The method of any of Aspects 17-18, wherein establishing the wireless communication session with the network entity associated with the VPLMN includes performing an IAB node integration procedure in the VPLMN associated with the IAB-DU.

Aspect 20: The method of Aspect 19, wherein performing the IAB node integration procedure in the VPLMN is based at least in part on a provisioned list including, for each of multiple preferred PLMNs, a DNN and S-NSSAI pair associated with an OAM PDU session, and an FQDN associated with an OAM server.

Aspect 21: The method of any of Aspects 17-18, wherein establishing the wireless communication session with the network entity associated with the VPLMN includes performing an inter-donor full migration procedure associated with the IAB-DU.

Aspect 22: The method of any of Aspects 1-16, wherein the access node functions are associated with a base station portion of the relay entity.

Aspect 23: The method of Aspect 22, wherein establishing the wireless communication session with the network entity associated with the VPLMN includes establishing a connection between the base station portion of the relay entity and an AMF associated with the VPLMN.

Aspect 24: The method of any of Aspects 22-23, wherein establishing the wireless communication session with the network entity associated with the VPLMN includes performing an onboarding procedure in the VPLMN associated with the base station portion of the relay entity.

Aspect 25: The method of Aspect 24, wherein performing the onboarding procedure in the VPLMN is based at least in part on a provisioned list including, for each of multiple preferred PLMNs, a DNN and S-NSSAI pair associated with an OAM PDU session, an FQDN associated with an OAM server, and a DNN and S-NSSAI pair to be used to establish a backhaul link.

Aspect 26: The method of Aspect 25, wherein performing the onboarding procedure in the VPLMN is based at least in part on the UE functions establishing an OAM PDU session using a DNN and an S-NSSAI associated with the VPLMN.

Aspect 27: The method of Aspect 26, further comprising receiving, from an OAM server associated with the VPLMN, a configuration associated with the base station portion of the relay entity.

Aspect 28: The method of Aspect 27, further comprising, based at least in part on receiving the configuration associated with the base station portion of the relay entity, establishing an N2 interface between the base station portion of the relay entity and an AMF associated with the VPLMN.

Aspect 29: The method of any of Aspects 22-23, wherein establishing the wireless communication session with the network entity associated with the VPLMN includes performing an inter-PLMN handover procedure associated with the base station portion of the relay entity.

Aspect 30: The method of Aspect 29, wherein performing the inter-PLMN handover procedure includes handing over a UE PDU session from an HPLMN to the VPLMN.

Aspect 31: The method of Aspect 30, wherein performing the inter-PLMN handover procedure is based at least in part on a provisioned list including, for each of multiple preferred PLMNs, a DNN and S-NSSAI pair associated with an OAM PDU session, an FQDN associated with an OAM server, and a DNN and S-NSSAI pair to be used to establish a backhaul link.

Aspect 32: The method of Aspect 31, wherein performing the inter-PLMN handover procedure is based at least in part on the UE functions establishing an OAM PDU session using a DNN and an S-NSSAI associated with the VPLMN.

Aspect 33: The method of Aspect 32, further comprising receiving, from an OAM server associated with the VPLMN, a configuration associated with the base station portion of the relay entity.

Aspect 34: The method of Aspect 33, further comprising, based at least in part on the provisioned list, establishing a PDU session for backhauling in the VPLMN.

Aspect 35: The method of Aspect 34, further comprising, based at least in part on receiving the configuration associated with the base station portion of the relay entity, establishing an N2 interface between the base station portion of the relay entity and an AMF associated with the VPLMN.

Aspect 36: The method of Aspect 35, further comprising handing over, by the relay entity, UEs connected to the relay entity from the HPLMN to the VPLMN.

Aspect 37: The method of Aspect 36, further comprising ending a wireless communication session with the HPLMN based at least in part on handing over the UEs connected to the relay entity from the HPLMN to the VPLMN.

Aspect 38: A method of wireless communication performed by a network entity associated with a VPLMN, comprising: establishing a wireless communication session with a relay entity, wherein the relay entity is configured to perform access node functions and UE functions, and wherein establishing the wireless communication session includes enabling wireless communication for both the access node functions and the UE functions via the VPLMN; and receiving, from the relay entity, a communication associated with the access node functions of the relay entity.

Aspect 39: The method of Aspect 38, further comprising transmitting, to the relay entity, an indication of whether the access node functions are permitted to operate in the VPLMN.

Aspect 40: The method of Aspect 39, wherein the indication is transmitted in response to a request, associated with the UE functions of the relay entity, for the access node functions to operate in the VPLMN.

Aspect 41: The method of any of Aspects 38-40, wherein establishing the wireless communication session with the relay entity includes the access node functions communicating with an HPLMN via a link between the UE functions and the network entity.

Aspect 42: The method of Aspect 41, further comprising receiving, from the relay entity, a request to operate radio resources of the HPLMN within the VPLMN.

Aspect 43: The method of any of Aspects 41-42, further comprising transmitting, to the relay entity, an indication of whether the access node functions are permitted to operate radio resources of the HPLMN within the VPLMN.

Aspect 44: The method of any of Aspects 38-43, wherein the access node functions are associated with an IAB-DU.

Aspect 45: The method of Aspect 44, wherein establishing the wireless communication session with the relay entity includes establishing a connection between the IAB-DU and the network entity.

Aspect 46: The method of any of Aspects 44-45, wherein establishing the wireless communication session with the relay entity includes performing an IAB node integration procedure in the VPLMN associated with the IAB-DU.

Aspect 47: The method of Aspect 46, wherein performing the IAB node integration procedure in the VPLMN is based at least in part on a provisioned list including, for each of multiple preferred PLMNs, a DNN and S-NSSAI pair associated with an OAM PDU session, and an FQDN associated with an OAM server.

Aspect 48: The method of any of Aspects 44-45, wherein establishing the wireless communication session with the relay entity includes performing an inter-donor full migration procedure associated with the IAB-DU.

Aspect 49: The method of any of Aspects 38-43, wherein the access node functions are associated with a base station portion of the relay entity.

Aspect 50: The method of Aspect 49, wherein establishing the wireless communication session with the relay entity includes establishing a connection between the base station portion of the relay entity and an AMF associated with the VPLMN.

Aspect 51: The method of any of Aspects 49-50, wherein establishing the wireless communication session with the relay entity includes performing an onboarding procedure in the VPLMN associated with the base station portion of the relay entity.

Aspect 52: The method of Aspect 51, wherein performing the onboarding procedure in the VPLMN is based at least in part on a provisioned list including, for each of multiple preferred PLMNs, a DNN and S-NSSAI pair associated with an OAM PDU session, an FQDN associated with an OAM server, and a DNN and S-NSSAI pair to be used to establish a backhaul link.

Aspect 53: The method of Aspect 52, wherein performing the onboarding procedure in the VPLMN is based at least in part on the UE functions establishing an OAM PDU session using a DNN and an S-NSSAI associated with the VPLMN.

Aspect 54: The method of Aspect 53, further comprising transmitting, to the relay entity, a configuration associated with the base station portion of the relay entity.

Aspect 55: The method of Aspect 54, further comprising, based at least in part on transmitting the configuration associated with the base station portion of the relay entity, establishing an N2 interface between the base station portion of the relay entity and an AMF associated with the VPLMN.

Aspect 56: The method of any of Aspects 49-50, wherein establishing the wireless communication session with the relay entity includes performing an inter-PLMN handover procedure associated with the base station portion of the relay entity.

Aspect 57: The method of Aspect 56, wherein performing the inter-PLMN handover procedure includes handing over a UE PDU session from an HPLMN to the VPLMN.

Aspect 58: The method of Aspect 57, wherein performing the inter-PLMN handover procedure is based at least in part on a provisioned list including, for each of multiple preferred PLMNs, a DNN and S-NSSAI pair associated with an OAM PDU session, an FQDN associated with an OAM server, and a DNN and S-NSSAI pair associated with a backhaul link.

Aspect 59: The method of Aspect 58, wherein performing the inter-PLMN handover procedure is based at least in part on the UE functions establishing an OAM PDU session using a DNN and an S-NSSAI associated with the VPLMN.

Aspect 60: The method of Aspect 59, further comprising transmitting, to the relay entity, a configuration associated with the base station portion of the relay entity.

Aspect 61: The method of Aspect 60, further comprising, based at least in part on the provisioned list, establishing a PDU session for backhauling in the VPLMN.

Aspect 62: The method of Aspect 61, further comprising, based at least in part on transmitting the configuration associated with the base station portion of the relay entity, establishing an N2 interface between the base station portion of the relay entity and an AMF associated with the VPLMN.

Aspect 63: An apparatus for wireless communication at a device, comprising a processor; memory coupled with the processor; and instructions stored in the memory and executable by the processor to cause the apparatus to perform the method of one or more of Aspects 1-37.

Aspect 64: A device for wireless communication, comprising a memory and one or more processors coupled to the memory, the one or more processors configured to perform the method of one or more of Aspects 1-37.

Aspect 65: An apparatus for wireless communication, comprising at least one means for performing the method of one or more of Aspects 1-37.

Aspect 66: A non-transitory computer-readable medium storing code for wireless communication, the code comprising instructions executable by a processor to perform the method of one or more of Aspects 1-37.

Aspect 67: A non-transitory computer-readable medium storing a set of instructions for wireless communication, the set of instructions comprising one or more instructions that, when executed by one or more processors of a device, cause the device to perform the method of one or more of Aspects 1-37.

Aspect 68: An apparatus for wireless communication at a device, comprising a processor; memory coupled with the processor; and instructions stored in the memory and executable by the processor to cause the apparatus to perform the method of one or more of Aspects 38-62.

Aspect 69: A device for wireless communication, comprising a memory and one or more processors coupled to the memory, the one or more processors configured to perform the method of one or more of Aspects 38-62.

Aspect 70: An apparatus for wireless communication, comprising at least one means for performing the method of one or more of Aspects 38-62.

Aspect 71: A non-transitory computer-readable medium storing code for wireless communication, the code comprising instructions executable by a processor to perform the method of one or more of Aspects 38-62.

Aspect 72: A non-transitory computer-readable medium storing a set of instructions for wireless communication, the set of instructions comprising one or more instructions that, when executed by one or more processors of a device, cause the device to perform the method of one or more of Aspects 38-62.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a relay entity, comprising:
a memory; and
one or more processors, coupled to the memory, configured to:
establish a wireless communication session with a network entity associated with a visited public land mobile network (VPLMN), wherein the relay entity is configured to perform access node functions and user equipment (UE) functions, and wherein establishing the wireless communication session includes enabling wireless communication for both the access node functions and the UE functions via the VPLMN; and
perform a relay service via the access node functions.

2. The apparatus of claim 1, wherein the one or more processors are further configured to determine whether the access node functions are permitted to operate in the VPLMN.

3. The apparatus of claim 2, wherein the one or more processors are further configured to determine whether the access node functions are permitted to operate in the VPLMN based at least in part on at least one of a provisioned list of preferred public land mobile networks (PLMNs), or a provisioned list of PLMNs in which the access node functions are not permitted to operate.

4. The apparatus of claim 3, wherein each of the preferred PLMNs includes a corresponding priority value.

5. The apparatus of claim 4, wherein the one or more processors are further configured to select the VPLMN based at least in part on a priority value associated with the VPLMN.

6. The apparatus of claim 2, wherein determining whether the access node functions are permitted to operate in the VPLMN is based at least in part on an indication received from the network entity.

7. The apparatus of claim 6, wherein the indication received from the network entity is received in response to a request, associated with the UE functions, for the access node functions to operate in the VPLMN.

8. The apparatus of claim 6, wherein establishing the wireless communication session with the network entity associated with the VPLMN is based at least in part on another VPLMN rejecting a request, associated with the UE functions, for the access node functions to operate in the other VPLMN.

9. The apparatus of claim 1, wherein the access node functions are associated with an integrated access and backhaul (IAB) distributed unit (IAB-DU).

10. The apparatus of claim 9, wherein the one or more processors are further configured to establish a connection between the IAB-DU and the network entity.

11. The apparatus of claim 9, wherein the one or more processors are further configured to perform an IAB node integration procedure in the VPLMN associated with the IAB-DU.

12. The apparatus of claim 11, wherein the one or more processors are further configured to perform the IAB node integration procedure in the VPLMN based at least in part on a provisioned list including, for each of multiple preferred public land mobile networks (PLMNs), a data network name (DNN) and single network slice selection assistance information (S-NSSAI) pair associated with an operation and maintenance (OAM) packet data unit (PDU) session, and a fully qualified domain name (FQDN) associated with an OAM server.

13. The apparatus of claim 9, wherein the one or more processors are further configured to perform an inter-donor full migration procedure associated with the IAB-DU.

14. An apparatus for wireless communication at a network entity associated with a visited public land mobile network (VPLMN), comprising:
a memory; and
one or more processors, coupled to the memory, configured to:
establish a wireless communication session with a relay entity, wherein the relay entity is configured to perform access node functions and user equipment (UE) functions, and wherein establishing the wireless communication session includes enabling wireless communication for both the access node functions and the UE functions via the VPLMN; and
receive, from the relay entity, a communication associated with the access node functions of the relay entity.

15. The apparatus of claim 14, wherein the one or more processors are further configured to transmit, to the relay entity, an indication of whether the access node functions are permitted to operate in the VPLMN.

16. The apparatus of claim 15, wherein the one or more processors are further configured to transmit the indication in response to a request, associated with the UE functions of the relay entity, for the access node functions to operate in the VPLMN.

17. The apparatus of claim 14, wherein the access node functions are associated with an integrated access and backhaul (IAB) distributed unit (IAB-DU).

18. The apparatus of claim 17, wherein the one or more processors are further configured to establish a connection between the IAB-DU and the network entity.

19. The apparatus of claim 17, wherein the one or more processors are further configured to perform an IAB node integration procedure in the VPLMN associated with the IAB-DU.

20. The apparatus of claim 19, wherein the one or more processors are further configured to perform the IAB node integration procedure in the VPLMN based at least in part on a provisioned list including, for each of multiple preferred public land mobile networks (PLMNs), a data network name (DNN) and single network slice selection assistance information (S-NSSAI) pair associated with an operation and maintenance (OAM) packet data unit (PDU) session, and a fully qualified domain name (FQDN) associated with an OAM server.

21. The apparatus of claim 17, wherein the one or more processors are further configured to perform an inter-donor full migration procedure associated with the IAB-DU.

22. A method of wireless communication performed by a relay entity, comprising:
establishing a wireless communication session with a network entity associated with a visited public land mobile network (VPLMN), wherein the relay entity is configured to perform access node functions and user equipment (UE) functions, and wherein establishing the wireless communication session includes enabling wireless communication for both the access node functions and the UE functions via the VPLMN; and
performing a relay service via the access node functions.

23. The method of claim 22, further comprising determining whether the access node functions are permitted to operate in the VPLMN.

24. The method of claim 23, wherein determining whether the access node functions are permitted to operate in the VPLMN is based at least in part on at least one of a provisioned list of preferred public land mobile networks (PLMNs), or a provisioned list of PLMNs in which the access node functions are not permitted to operate.

25. The method of claim 23, wherein determining whether the access node functions are permitted to operate in the VPLMN is based at least in part on an indication received from the network entity.

26. The method of claim 22, wherein the access node functions are associated with an integrated access and backhaul (IAB) distributed unit (IAB-DU).

27. The method of claim 26, wherein establishing the wireless communication session with the network entity associated with the VPLMN includes establishing a connection between the IAB-DU and the network entity.

28. A method of wireless communication performed by a network entity associated with a visited public land mobile network (VPLMN), comprising:
establishing a wireless communication session with a relay entity, wherein the relay entity is configured to perform access node functions and user equipment (UE) functions, and wherein establishing the wireless communication session includes enabling wireless communication for both the access node functions and the UE functions via the VPLMN; and
receiving, from the relay entity, a communication associated with the access node functions of the relay entity.

29. The method of claim 28, wherein the access node functions are associated with an integrated access and backhaul (IAB) distributed unit (IAB-DU).

30. The method of claim 29, wherein establishing the wireless communication session with the relay entity includes establishing a connection between the IAB-DU and the network entity.
